(19) United States
(12) Patent Application Publication
(10) Pub. No.: US 2025/0033553 A1
(43) Pub. Date: Jan. 30, 2025

(54) DETECTOR-ATTACHED VEHICULAR LIGHTING DEVICE

(71) Applicant: HONDA MOTOR CO., LTD., Tokyo (JP)

(72) Inventors: Yuki SASANUMA, Tokyo (JP); Takato WATANABE, Tokyo (JP); Keishi SHIOMI, Tokyo (JP)

(21) Appl. No.: 18/780,516

(22) Filed: Jul. 23, 2024

(30) Foreign Application Priority Data
Jul. 28, 2023 (JP) 2023-123411

(51) Int. Cl. B60Q 1/00; B60Q 1/04

(52) U.S. Cl. CPC B60Q 1/0023; B60Q 1/0408

(57) ABSTRACT

A detector-attached vehicular lighting device includes a lighting unit and a detection unit. The lighting unit includes a light source and a lens. The lens is formed with a storage recess that is recessed in a counter-detection direction other than a detection direction. The detection unit includes a detector, a bracket, and a cover. At least a part of the detector is stored in the storage recess. The bracket supports the detector from a side in the counter-detection direction. The cover is provided with a flange that projects in the counter-detection direction. The cover is attached to the bracket by engagement of the bracket and the flange at a predetermined location of engagement. The detector has, at an end in the detection direction, a detection surface for detecting an object. The flange extends, above the detector, further toward the side in the counter-detection direction than the detection surface.

This application is based on and claims the benefit of priority from Japanese Patent Application No. 2023-123411, filed on 28 Jul. 2023, the content of which is incorporated herein by reference.

### BACKGROUND OF THE INVENTION

### Field of the Invention

The present invention relates to a vehicular lighting device including a detector such as a radar.

### Related Art

Recently, momentum has increased for initiatives to provide sustainable transportation systems that take into consideration those people who are in vulnerable situations among traffic participants. To achieve such initiatives, the applicant has focused on, through research and development relating to driving assistance techniques, further improvements in safety and convenience in traffic.

Patent Document 1: Japanese Unexamined Patent Application, Publication No. 2021-91303

### SUMMARY OF THE INVENTION

The inventors have studied adopting a configuration described below in a detector-attached vehicular lighting device including a detector such as a radar used in the driving assistance techniques. A detector-attached vehicular lighting device includes a lighting unit and a detection unit. The detection unit detects an object on a side in a predetermined detection direction.

The lighting unit includes a light source and a lens. The lens covers the light source from the side in the detection direction. The lens is formed with a storage recess that is recessed in a counter-detection direction opposite to the detection direction. The detection unit includes a detector, a bracket, and a cover. The detector has at least a part stored in the storage recess. The detector has, at an end on the side in the detection direction, a detection surface for detecting an object. The bracket supports the detector from a side in the counter-detection direction.

The cover covers the detector from the side in the detection direction. The cover is provided with a flange that projects toward the side in the counter-detection direction. The bracket and the flange engage at a predetermined location of engagement, and the cover is thus attached to the bracket.

The inventors have paid attention to points that such issues described below may arise in the detector-attached vehicular lighting device. When snow or water enters inside the storage recess from a gap between an upper end of the cover and an inner peripheral surface of the storage recess, the snow or water may enter between the detection surface and a back surface of the cover, possibly leaving negative effects on detection performance of the detector.

In view of the situations described above, an object of the present invention is to suppress entry of snow or water between a detection surface and a back surface of a cover.

The inventors have found that providing the cover with a flange that projects, above the detector, further toward the side in the counter-detection direction than the detection surface makes it possible to achieve the object described above, and have reached the present invention. The present invention relates to a detector-attached vehicular lighting device having configurations according to (1) to (5) described below.

(1) A detector-attached vehicular lighting device including:
a lighting unit mounted on a vehicle; and
a detection unit that detects an object on a side in a predetermined detection direction,
in which
the lighting unit includes a light source and a lens that covers the light source from the side in the detection direction, the lens being formed with a storage recess that is recessed in a counter-detection direction opposite to the detection direction,
the detection unit includes a detector having at least a part stored in the storage recess, a bracket that supports the detector from a side in the counter-detection direction, and a cover that covers the detector from the side in the detection direction,
the cover is provided with a flange that projects in the counter-detection direction,
the cover is attached to the bracket by engagement of the bracket and the flange at a predetermined location of engagement,
the detector has, at an end in the detection direction, a detection surface for performing the detection, and
the flange projects, above the detector, further toward the side in the counter-detection direction than the detection surface.

According to the present configuration, the flange projects, above the detector, further toward the counter-detection direction than the detection surface. Therefore, even when snow or water enters inside the storage recess from a gap between an upper end of the cover and an inner peripheral surface of the storage recess, the flange makes it possible to suppress entry of the snow or water between the detection surface and a back surface of the cover.

(2) The detector-attached vehicular lighting device according to (1) described above in which the flange projects, above the detector, further toward the side in the counter-detection direction than an end face on the side in the counter-detection direction of the detector.

According to the present configuration, even when snow or water drops downward from an end on the side in the counter-detection direction of the flange, the snow or water drops toward the side in the counter-detection direction than the detector. Therefore, it is possible to more securely suppress entry of snow or water between the detection surface and the back surface of the cover.

(3) The detector-attached vehicular lighting device according to (1) or (2) described above in which the location of the engagement is positioned on the side in the counter-detection direction relative to the detection surface.

According to the present configuration, since the location of the engagement is positioned on the side in the counter-detection direction relative to the detection surface, even when snow or water drops downward from the location of the engagement, the snow or water drops toward the side in the counter-detection direction than the detection surface. Thereby, it is possible to more securely suppress entry of snow or water between the detection surface and the back surface of the cover.

(4) The detector-attached vehicular lighting device according to (1) or (2) described above in which the bracket is provided with an engagement projection that projects in the detection direction to allow the flange to be in engagement with the engagement projection at the location of the engagement,
the bracket is provided with a receiver that projects within a range including at least a position immediately below a part of the engagement projection,
both ends in width directions of the receiver are positioned more outward in the width directions than both ends in width directions of the engagement projection, and
an upper surface of the receiver is inclined downward as the surface advances in the counter-detection direction.

According to the present configuration, even when snow or water drops downward from ends in the width directions of the projection, the receiver makes it possible to receive the snow or water and to lead the snow or water in the counter-detection direction. Therefore, it is possible to more securely suppress entry of snow or water between the detection surface and the back surface of the cover.

(5) The detector-attached vehicular lighting device according to (1) or (2) described above in which
the bracket is provided with an enclosure,
the enclosure has an inner side projection and an outer side projection that are provided side by side in a direction orthogonal to the detection direction, and project in the detection direction, and
the flange is disposed between the inner side projection and the outer side projection.

According to the present configuration, the enclosure being provided in addition to the location of the engagement makes it possible to more stably attach the cover to the bracket.

With the configuration according to (1) described above, it is possible to suppress entry of snow or water between the detection surface and the back surface of the cover. In addition, with the configurations according to (2) to (5) described above, which cite the configuration according to (1) described above, it is possible to achieve respective additional effects.

### BRIEF DESCRIPTION OF THE DRAWINGS

FIG. 1 is a front view illustrating a detector-attached vehicular lighting device according to a first embodiment;

FIG. 2 is a front view illustrating a detection unit;

FIG. 3 is a view illustrating a cross section taken along line iii-iii illustrated in FIG. 2;

FIG. 4 is an exploded perspective view illustrating the detector-attached vehicular lighting device;

FIG. 5 is a perspective view illustrating an edge of the detection unit;

FIG. 6 is a perspective view illustrating a bracket and the detector;

FIG. 7 is a perspective view illustrating an engagement projection on the bracket and those around the engagement projection;

FIG. 8 is a view illustrating a cross section taken along line viii-viii illustrated in FIG. 2;

FIG. 9 is a view illustrating in an enlarged manner a part indicated by ix illustrated in FIG. 3;

FIG. 10 is a view illustrating a situation when releasing the engagement from the state illustrated in FIG. 8;

FIG. 11 is a view illustrating a situation when releasing the engagement from the state illustrated in FIG. 9;

FIG. 12 is a view illustrating a cross section taken along line xii-xii illustrated in FIG. 2;

FIG. 13 is a view illustrating in an enlarged manner a part of those illustrated in FIG. 12; and

FIG. 14 is a view illustrating a cross section taken along line xiv-xiv illustrated in FIG. 2.

### DETAILED DESCRIPTION OF THE INVENTION

An embodiment of the present invention will now be described herein with reference to the accompanying drawings. However, the present invention is not limited to the embodiment described below. It is possible to appropriately make modifications and implementations without departing from the scope of the present invention.

### First Embodiment

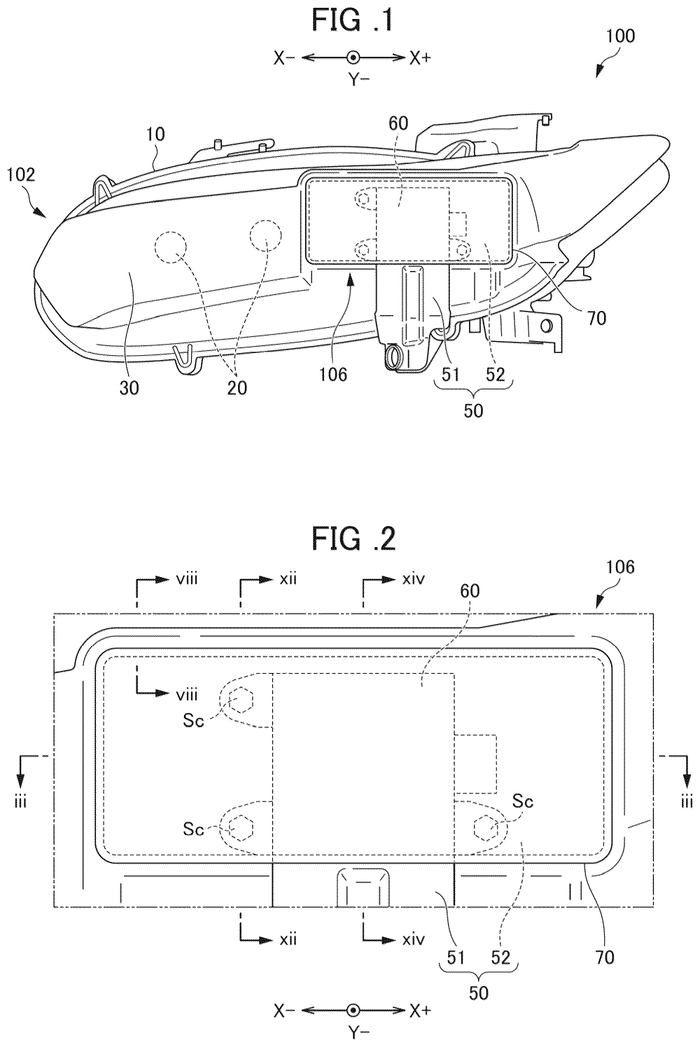

A detector-attached vehicular lighting device 100 illustrated in FIG. 1 is a headlight on a left side of a vehicle, and is mounted on the vehicle. The detector-attached vehicular lighting device 100 includes a lighting unit 102 and a detection unit 106. The lighting unit 102 includes a housing 10, a light source 20, and a lens 30. The detection unit 106 includes a detector 60, a bracket 50, and a cover 70. In the present embodiment, the detector 60 is a radar device that emits electric waves, detects their reflective waves, and detects an object.

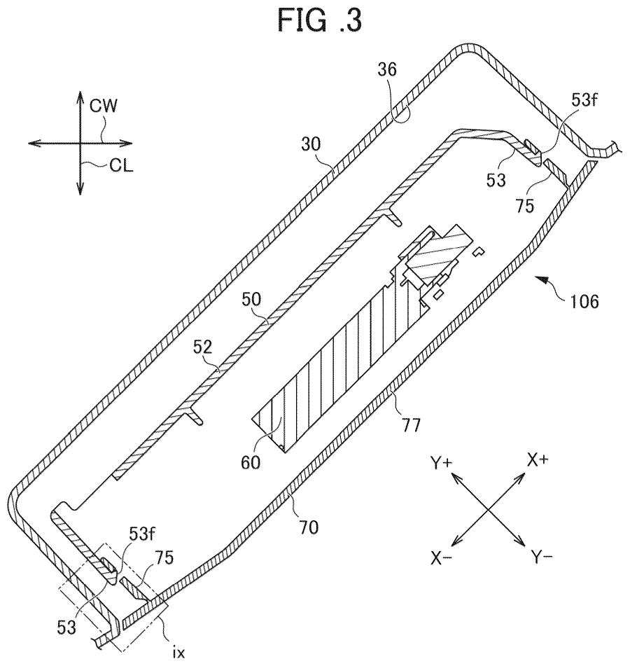

Hereinafter, as illustrated in FIG. 3, a direction in which the detector 60 emits electric waves, that is, a direction in which an object is detected will be referred to as a “Y− direction”, and its opposite direction will be referred to as a “Y+ direction”. Note that the “Y− direction” may be replaced with and read as a “detection direction”, and the “Y+ direction” may be replaced with and read as a “counter-detection direction”. The “Y− direction” and the “Y+ direction” will be hereinafter collectively referred to as “Y directions”. The Y directions are directions inclined with respect to vehicle length directions CL in a horizontal plane. Directions orthogonal to the Y directions in the horizontal plane will be hereinafter referred to as “X directions”. Furthermore, in the X directions, a direction heading inward in vehicle-width directions CW will be hereinafter referred to as an “X− direction”, and its opposite direction will be hereinafter referred to as an “X+ direction”.

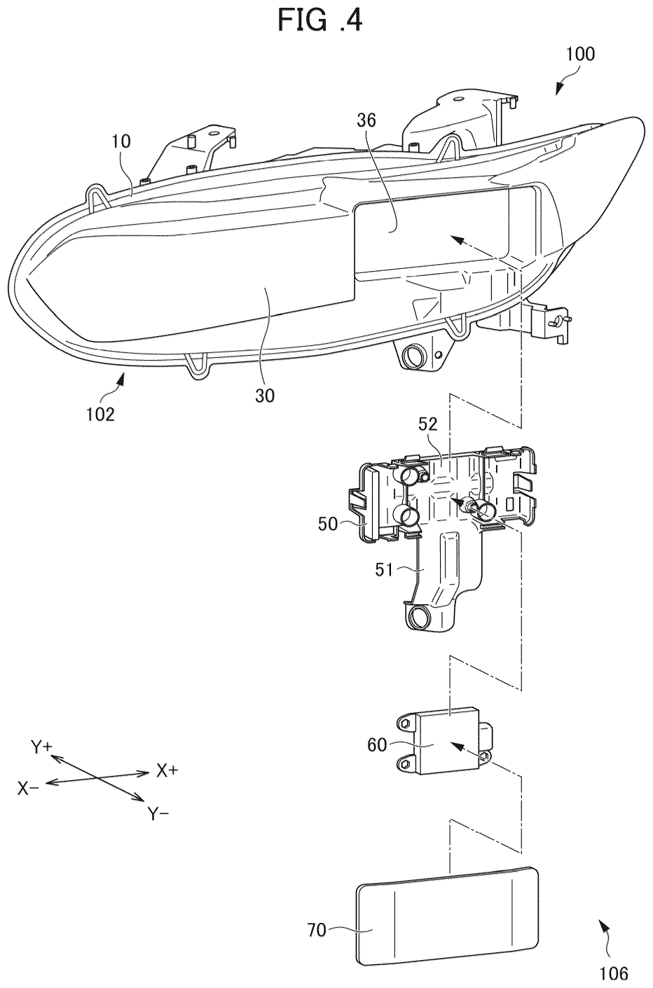

The housing 10 illustrated in FIG. 1 has a box shape that is open in the Y− direction. The light source 20 is installed inside the housing 10, and emits light toward a side in the Y− direction. The lens 30 is attached to the housing 10, and covers the light source 20 from the side in the Y− direction. As illustrated in FIG. 4, the lens 30 is formed with a storage recess 36 that is recessed toward a side in the Y+ direction. The storage recess 36 is open in the Y− direction and downward.

As illustrated in FIG. 4, the bracket 50 is installed inside the storage recess 36. As illustrated in FIG. 6, the bracket 50 includes a bracket main body 52 and an attachment 51. The bracket main body 52 has a plate shape extending in upper and lower directions and the X directions. The attachment 51 projects downward from a lower end of the bracket main body 52. As illustrated in FIG. 1, a lower end of the attachment 51 is fixed, below the lens 30, to a vehicle body or the housing 10. Thereby, the bracket main body 52 is installed inside the storage recess 36.

As illustrated in FIG. 6, the detector 60 is attached on a surface on the side in the Y− direction of the bracket main body 52 with screws, for example, as illustrated in FIG. 2. That is, the bracket 50 supports the detector 60 on the side in the Y+ direction. Thereby, as illustrated in FIG. 3, the detector 60 is stored in the storage recess 36. Note that, in the present embodiment, the detector 60 is wholly stored in the storage recess 36. However, only a part of the detector 60 may instead be stored in the storage recess 36. Specifically, for example, an end on the side in the Y− direction of the detector 60 may project from an opening of the storage recess 36 in the Y− direction, and a central part of the cover 70 may project from the opening of the storage recess 36 in the Y− direction.

As illustrated in FIG. 6, the detector 60 has a detection surface 60s for performing detection at the end on the side in the Y− direction. Specifically, the detector 60 emits electric waves from the detection surface 60s toward the side in the Y− direction, detects their reflective waves with the detection surface 60s, and performs detection on the side in the Y− direction.

The bracket main body 52 is provided with a plurality of enclosures 57, a plurality of engagement projections 53, and a plurality of receivers 54.

As illustrated in FIG. 6, the enclosures 57 are provided on an upper edge, a lower edge, and an edge on a side in the X+ direction of the bracket main body 52. The enclosures 57 each project in the Y− direction. In the bracket main body 52, the enclosures 57 on the upper edge will be hereinafter referred to as “upper side enclosures 57”, the enclosures 57 on the lower edge will be hereinafter referred to as “lower side enclosures 57”, and the enclosures 57 on the edge on the side in the X+ direction will be hereinafter referred to as “X+ side enclosures 57”.

The enclosures 57 each have an inner side projection 57a and an outer side projection 57b. The inner side projection 57a and the outer side projection 57b of each of the upper side and lower side enclosures 57 are provided side by side in the upper and lower directions and project in the Y− direction. The inner side projection 57a and the outer side projection 57b of each of the X+ side enclosures 57 are provided side by side in the X directions and project in the Y− direction. That is, the inner side projection 57a and the outer side projection 57b are provided side by side on a side in directions orthogonal to the Y directions and project in the Y− direction. As illustrated in FIG. 13, a tip of the outer side projection 57b of each of the upper side enclosures 57 projects upward, and is in engagement with an inner periphery of the storage recess 36.

As illustrated in FIG. 6, the engagement projections 53 are provided on the upper edge, the lower edge, an edge on a side in the X− direction, and the edge on the side in the X+ direction of the bracket main body 52. The engagement projections 53 each project in the Y− direction. The engagement projections 53 on the upper edge of the bracket main body 52 will be hereinafter referred to as “upper side engagement projections 53”, and the engagement projections 53 on the lower edge will be hereinafter referred to as “lower side engagement projections 53”. Furthermore, the engagement projection 53 on the edge on the side in the X− direction of the bracket main body 52 will be hereinafter referred to as an “X− side engagement projection 53”, and the engagement projection 53 on the edge on the side in the X+ direction will be hereinafter referred to as an “X+ side engagement projection 53”. Width directions of the upper side and lower side engagement projections 53 correspond to the X directions, and width directions of the X− side and X+ side engagement projections 53 correspond to the upper and lower directions.

A hook 53f is provided at an end on the side in the Y− direction of each of the engagement projections 53. The engagement projections 53, include an engagement protrusion 53 in which the hooks 53f project inward, that is, toward a side of the detector 60, and an engagement protrusion 53 in which the hooks 53f project outward, that is, toward an opposite side to the side of the detector 60. Specifically, in the present embodiment, the hooks 53f of the upper side engagement projections 53 project outward, that is, upward. Furthermore, the hooks 53f of the lower side engagement projections 53 project inward, that is, upward. Furthermore, the hook 53f of the X− side engagement projection 53 projects inward, that is, in the X+ direction. Furthermore, the hook 53f of the X+ side engagement projection 53 projects outward, that is, in the X+ direction.

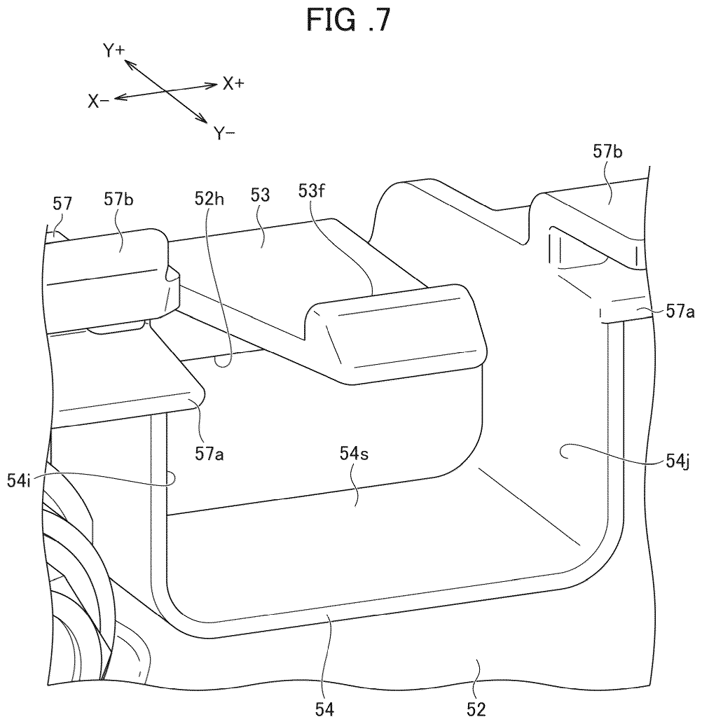

As illustrated in FIG. 6, the receivers 54 are present for the upper side engagement projections 53, respectively. As illustrated in FIG. 7, the receivers 54 each have a U shape, when viewed in the Y directions. Each of the receivers 54 project from the bracket main body 52 within a range including at least a position immediately below a part near a base of the engagement projections 53. A width in the X directions of the receivers 54 is wider than a width in the X directions of the engagement projections 53. Therefore, both ends in the X directions of each of the receivers 54 are positioned more outward in the X directions than both ends in the X directions of the engagement projections 53. More specifically, inner side surfaces 54i and 54j on both the sides in the X directions of each of the receivers 54 are positioned more outward in the X directions than both the ends in the X directions of the engagement projections 53. An upper surface 54s on a bottom of each of the receivers 54 is gently inclined downward as the surface advances in the Y+ direction. A water drain hole 52h is provided on a part positioned inside a base of each of the receivers 54 on the bracket main body 52.

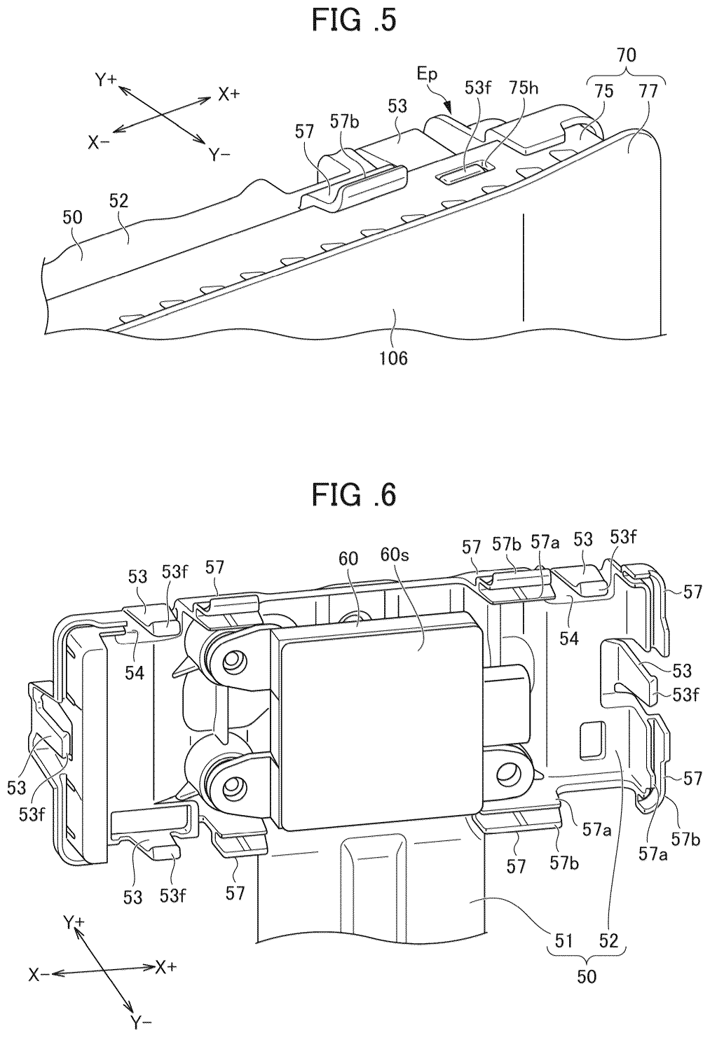

As illustrated in FIG. 5, the cover 70 includes a cover main body 77 and a flange 75. The cover main body 77 has a plate shape extending in the upper and lower directions and the X directions. The flange 75 extends in the Y+ direction from a part positioned slightly more inward than an edge of the cover main body 77. Engagement holes 75h are provided at a plurality of locations on the flange 75. Specifically, the engagement holes 75h are provided at locations corresponding to the hooks 53f.

As illustrated in FIG. 13, the flange 75 is inserted between the inner side projection 57a and the outer side projection 57b of each of the enclosures 57, as illustrated in FIG. 5, inner peripheral surfaces of the engagement holes 75h are in engagement with the hooks 53f, and the cover 70 is attached to the bracket 50. Locations where the hooks 53f and the inner peripheral surfaces of the engagement holes 75h are in engage will be hereinafter referred to as “locations of engagement Ep”. As illustrated in FIG. 3, the cover main body 77 covers the detector 60 from the side in the Y− direction. The cover 70 is comprised of resin, for example, and allowing electromagnetic waves to pass through.

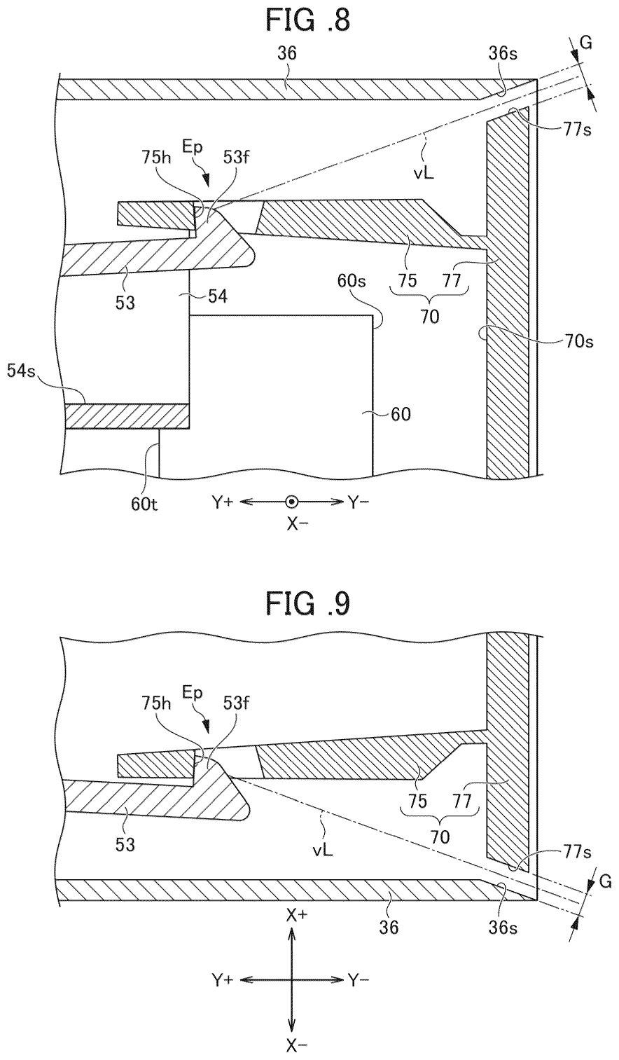

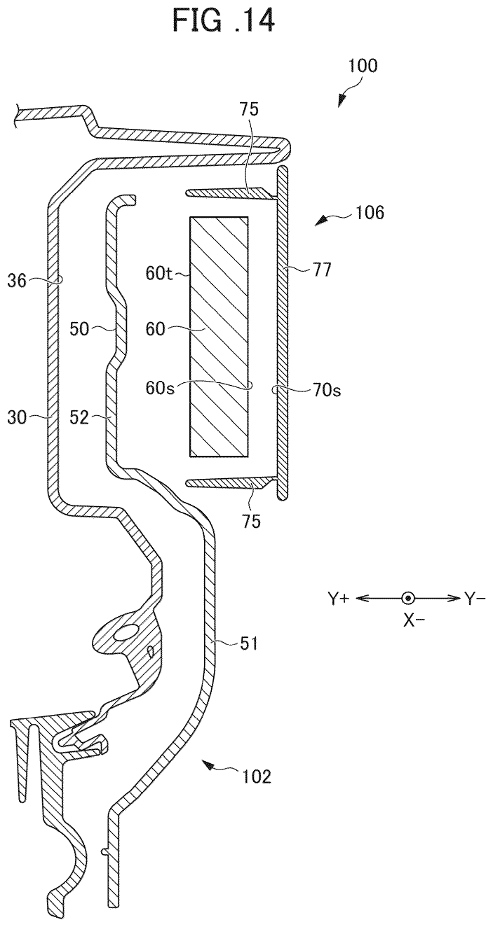

As illustrated in FIG. 14, the flange 75 projects further toward the side in the Y+ direction than the detection surface 60s. More specifically, the flange 75 projects further toward the side in the Y+ direction than an end face 60t on the side in the Y+ direction of the detector 60. As illustrated in FIG. 8, the locations of engagement Ep are positioned nearer the side in the Y+ direction than the detection surface 60s.

As illustrated in FIGS. 8 and 9, gaps G are formed between the edge of the cover main body 77 and the inner peripheral surface of the storage recess 36. Specifically, as illustrated in FIG. 8, upper side gaps G are formed between an upper end of the cover main body 77 and the inner peripheral surface of the storage recess 36. Furthermore, as illustrated in FIG. 9, an X− side gap G is formed between an end in the X− direction of the cover main body 77 and the inner peripheral surface of the storage recess 36. Furthermore, an X+ side gap (not illustrated) is formed between an end in the X+ direction of the cover main body 77 and the inner peripheral surface of the storage recess 36.

As illustrated in FIG. 8, virtual straight lines extending from parts, which are adjacent to the locations of engagement Ep, of the gaps G toward the locations of engagement Ep will be hereinafter referred to as “insertion virtual lines vL”, respectively. Lens side guide surfaces 36s extending along the insertion virtual lines vL are provided on parts, which are adjacent to the insertion virtual lines vL, respectively, of the inner peripheral surface of the storage recess 36, that is, parts facing the gaps G. Cover side guide surfaces 77s extending along the insertion virtual lines vL are provided on parts, which are adjacent to the insertion virtual lines vL, respectively, of the cover main body 77. Specifically, the lens side guide surfaces 36s and the cover side guide surfaces 77s are all parallel to the insertion virtual lines vL, respectively. Furthermore, the lens side guide surfaces 36s and the cover side guide surfaces 77s are parallel to each other, respectively.

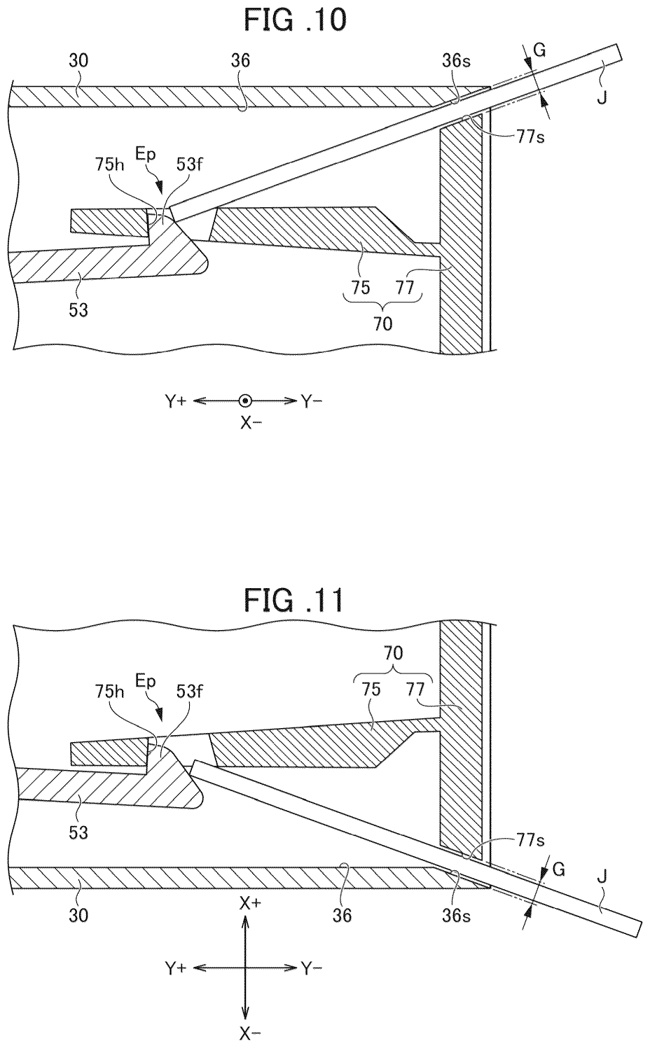

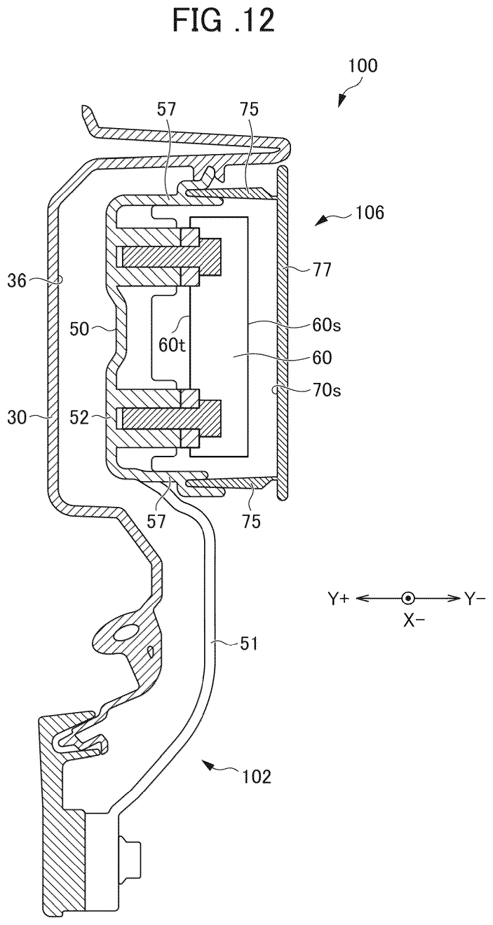

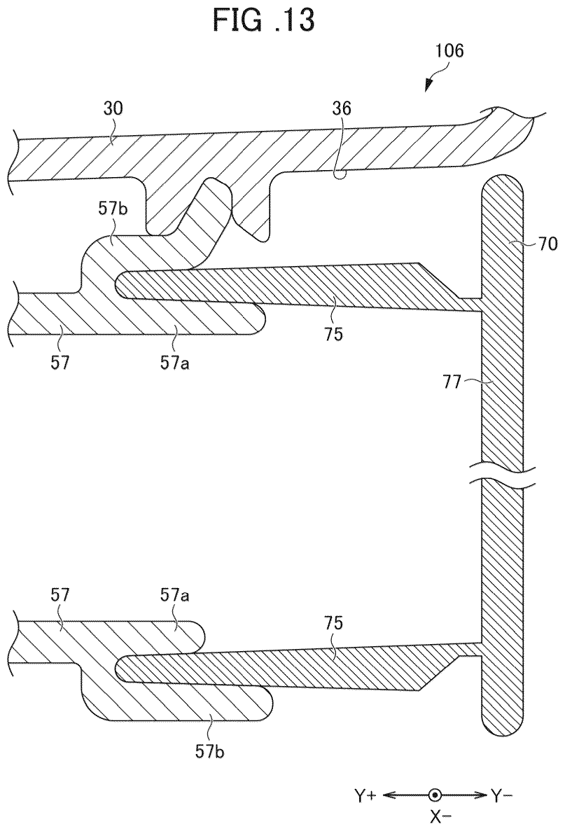

Next, the cover removal method according to the present embodiment will now be described herein. The detector-attached vehicular lighting device 100 illustrated in FIG. 1 above is prepared. Next, as illustrated in FIGS. 10 and 11, a jig J having a bar shape is inserted into the gap G along the lens side guide surface 36s and the cover side guide surface 77s, that is, along the insertion virtual lines vL toward the locations of engagement Ep. Thus, the engagement of the inner peripheral surfaces of the engagement holes 75h with respect to each of the hooks 53f at the locations of engagement Ep is released with a tip of the jig J.

Specifically, as illustrated in FIG. 10, regarding each upper engagement protrusion 53, the hooks 53f is pressed with the tip of the jig J to release the engagement of the inner peripheral surfaces of the engagement holes 75h with respect to the hooks 53f for the upper side engagement projections 53. Similarly, the engagement is released for the X+ side engagement projection 53. That is, regarding each of the hooks 53f projecting outward, the hook 53f is each pressed with the tip of the jig J to release the engagement of each of the inner peripheral surfaces of the engagement holes 75h with respect to each of the hooks 53f.

On the other hand, as illustrated in FIG. 11, regarding the X− side engagement projection 53, the tip of the jig J is pressed between the hook 53f and the inner peripheral surface of the engagement hole 75h. Thereby, the hook 53f is pressed toward the side in the X− direction with the tip of the jig J to release the engagement of the inner peripheral surface of the engagement hole 75h with respect to the hook 53f. Similarly, the engagement is released for the lower side engagement projections 53. That is, regarding each of the hooks 53f projecting inward, the tip of the jig J is pressed between the hook 53f and the inner peripheral surface of the engagement hole 75h to release the engagement of the inner peripheral surface of the engagement hole 75h with respect to the hooks 53f.

The configuration and effects of the present embodiment will now be summarized below.

As illustrated in FIG. 14, above the detector 60, the flange 75 projects more than the detection surface 60s toward the side in the Y+ direction. Therefore, even when snow or water enters inside the storage recess 36 from the gaps G between an upper end of the cover 70 and the inner peripheral surface of the storage recess 36, the flange 75 makes it possible to suppress entry of the snow or water between the detection surface 60s and a back surface 70s of the cover.

More specifically, above the detector 60, the flange 75 extends further toward the side in the Y+ direction than the end face 60t on the side in the Y+ direction of the detector 60. Therefore, even when snow or water drops downward from an end on the side in the Y+ direction of the flange 75, the snow or water drops toward the side in the Y+ direction than the detector 60. Thereby, it is possible to more securely suppress entry of snow or water between the detection surface 60s and the back surface 70s of the cover.

Furthermore, as illustrated in FIG. 8, the locations of engagement Ep are positioned nearer the side in the Y+ direction than the detection surface 60s. Therefore, even when snow or water drops downward from the engagement holes 75h at the locations of engagement Ep, the snow or water drops toward the side in the Y+ direction than the detection surface 60s. Thereby, it is also possible to more securely suppress entry of snow or water between the detection surface 60s and the back surface 70s of the cover.

In addition, as illustrated in FIG. 7, the bracket 50 is provided with the receivers 54 each projecting within the range including at least a position immediately below a part of the engagement projections 53. Both the ends in the X directions of the receiver 54 is positioned more outward in the X directions than both the ends in the X directions of the engagement projections 53. The upper surface 54s on the bottom of each of the receivers 54 is inclined downward as the surface advances in the Y+ direction. Therefore, even when snow or water drops from the ends in the X directions of the engagement projections 53 illustrated in FIG. 5, the receivers 54 illustrated in FIG. 7 make it possible to receive the snow or water and to lead the snow or water toward the side in the Y+ direction. Thus, it is possible to drain, from the water drain holes 52h, the snow or water toward the side in the Y+ direction than the bracket. Thereby, it is thus also possible to more securely suppress entry of snow or water between the detection surface 60s and the back surface 70s of the cover.

As illustrated in FIG. 6, the bracket 50 is provided with the enclosures 57. The enclosures 57 each have the inner side projection 57a and the outer side projection 57b that are provided side by side on the side in the direction orthogonal to the Y directions and that project toward the side in the Y− direction. As illustrated in FIG. 13, the flange 75 is disposed between the inner side projection 57a and the outer side projection 57b of each of the enclosures 57. The enclosures 57 in addition to the locations of engagement Ep as described above make it possible to more stably attach the cover 70 to the bracket 50.

As illustrated in FIGS. 8 and 9, the lens side guide surfaces 36s and the cover side guide surfaces 77s both extend along the insertion virtual lines vL, respectively. Therefore, as illustrated in FIGS. 10 and 11, inserting the jig J having the bar shape along each of the lens side guide surfaces 36s and each of the cover side guide surfaces 77s makes it possible to allow the tip of the jig J to reach each of the locations of engagement Ep. With the jig J, it is possible to release the engagement of the cover 70 with respect to the bracket 50. Therefore, according to the present embodiment, it is possible to make the cover 70 removable from the bracket 50 while limiting as much as possible removal of parts other than the cover 70 and introduction of a special shape for removing the cover.

### Other Embodiments

It is possible to modify the embodiment described above as described below, for example. The detector-attached vehicular lighting device 100 may be a headlight on a right side, which is provided in a left-and-right reversed manner from those illustrated in FIG. 1. The detector 60 illustrated in FIG. 3 may be a sonar device that emits sound waves and detects their reflective waves.

### EXPLANATION OF REFERENCE NUMERALS

20 Light source
30 Lens
36 Storage recess
50 Bracket
53 Engagement projection
54 Receiver
54s Upper surface of receiver
57 Enclosure
57a Inner side projection
57b Outer side projection
60 Detector
60s Detection surface
60t End face on side in Y+ direction of detector
70 Cover
75 Flange
100 Detector-attached vehicular lighting device
102 Lighting unit
106 Detection unit
Ep Location of engagement
X Width direction of engagement projection
Y− Detection direction
Y+ Counter-detection direction

What is claimed is:

1. A detector-attached vehicular lighting device comprising:
a lighting unit mounted on a vehicle; and
a detection unit that detects an object on a side in a predetermined detection direction,
wherein
the lighting unit includes a light source and a lens that covers the light source from the side in the detection direction, the lens being formed with a storage recess that is recessed in a counter-detection direction opposite to the detection direction,
the detection unit includes a detector having at least a part stored in the storage recess, a bracket that supports the detector from a side in the counter-detection direction, and a cover that covers the detector from the side in the detection direction,
the cover is provided with a flange that projects in the counter-detection direction,
the cover is attached to the bracket by engagement of the bracket and the flange at a predetermined location of engagement,
the detector has, at an end in the detection direction, a detection surface for performing the detection, and
the flange projects, above the detector, further toward the side in the counter-detection direction than the detection surface.

2. The detector-attached vehicular lighting device according to claim 1, wherein the flange projects, above the detector, further toward the side in the counter-detection direction than an end face on the side in the counter-detection direction of the detector.

3. The detector-attached vehicular lighting device according to claim 1, wherein the location of the engagement is positioned on the side in the counter-detection direction relative to the detection surface.

4. The detector-attached vehicular lighting device according to claim 1, wherein
the bracket is provided with an engagement projection that projects in the detection direction to allow the flange to be in engagement with the engagement projection at the location of the engagement,
the bracket is provided with a receiver that projects within a range including at least a position immediately below a part of the engagement projection,
both ends in width directions of the receiver are positioned more outward in the width directions than both ends in width directions of the engagement projection, and
an upper surface of the receiver is inclined downward as the surface advances in the counter-detection direction.

5. The detector-attached vehicular lighting device according to claim 1, wherein
the bracket is provided with an enclosure,
the enclosure has an inner side projection and an outer side projection that are provided side by side in a direction orthogonal to the detection direction, and project in the detection direction, and
the flange is disposed between the inner side projection and the outer side projection.
